(19) United States
(12) Patent Application Publication
(10) Pub. No.: US 2009/0049379 A1
(43) Pub. Date: Feb. 19, 2009

(54) USER INTERFACE TO BROWSE SYNDICATION DATA MIXING MODULE CONFIGURATIONS

(75) Inventors: Jonathan James TREVOR, Santa Clara, CA (US); Daniel Joseph RAFFEL, San Francisco, CA (US); Pasha SADRI, Menlo Park, CA (US); Edward HO, San Jose, CA (US)

Correspondence Address: BEYER LAW GROUP LLP/YAHOO, PO BOX 1687, CUPERTINO, CA, 95015-1687, US

(73) Assignee: YAHOO! INC., Sunnyvale, CA (US)

(21) Appl. No.: 11/838,802

(22) Filed: Aug. 14, 2007

(51) Int. Cl. G06F 3/00

(52) U.S. Cl. 715/700

(57) ABSTRACT

A user interface is configured for browsing pipes. The pipes are characterized by a plurality of metadata values, including metadata values not discernible from the pipes themselves. Display is caused of a first list of pipe indications for pipes characterized by metadata values, of at least a first category of metadata, satisfying particular criteria. Also, display is caused of a first list of metadata values for at least a second category of metadata, other than the first category of metadata, the pipes of the first list of pipe indications being categorized by the metadata values of the first list of metadata values. Display is caused of a second list of pipe indications characterized by a selected at least one of the metadata values of the received first list of metadata values, as well as of a second list of metadata values, the pipes of the second list of pipe indications being categorized by the metadata values of the second list of metadata values.

### BACKGROUND

The assignees of the present patent application have developed a pipe specification editor and execution engine which is disclosed in co-pending U.S. patent application Ser. No. 11/613,960—the '960 application—having Attorney Docket Number YAH1P039 and filed Dec. 20, 2006. The '960 application is incorporated herein by reference in its entirety. While the '960 disclosure and related material are discussed in this Background, this discussion is not meant to state or imply that the '960 disclosure and related material are prior art to the present patent application.

The disclosed pipe specification editor system provides a graphical user interface to receive a user-specified configuration—a pipe—to accomplish aggregating and manipulate syndication data feeds. More particularly, the disclosed pipe specification editor system may be used to create syndication feed data “mashups” to combine content from more than one source, including at least one syndication data feed, into an integrated experience.

Furthermore, not only may users create pipes for their own immediate use but, in addition, users may save pipes and “call” them like any other syndication date feed. A pipe may be published to be shared with other users, allowing other users to clone the pipe, add their own improvements to the pipe, or use the pipe as a subcomponent in their own created pipes.

A hosted pipe is a web-based interface that allows a user to execute a pipe that the user or another user has configured and published. This is a useful mechanism for quickly determining what type of content a pipe outputs. It is also a jumping off point for subscribing to a pipe in a feed reader, viewing how the pipe was constructed, or cloning the pipe for further modification.

### SUMMARY

In accordance with an aspect, a method is provided to operate a user interface configured for browsing pipes. The pipes are characterized by a plurality of metadata values, the plurality of metadata values including metadata values not discernible from the pipes themselves. Display is caused of a first list of pipe indications for pipes characterized by metadata values, of at least a first category of metadata, satisfying particular criteria. Also, display is caused of a first list of metadata values for at least a second category of metadata, other than the first category of metadata, the pipes of the first list of pipe indications being categorized by the metadata values of the first list of metadata values.

A selection may be received of at least one of the metadata values of the first list of metadata values. Display is caused of a second list of pipe indications characterized by the selected at least one of the metadata values of the received first list of metadata values. Furthermore, display may be caused of a second list of metadata values, the pipes of the second list of pipe indications being categorized by the metadata values of the second list of metadata values.

In some examples, each pipe of the second list of pipe indications is a member of the first list of pipes indications. In some examples, at least some pipes of the second list of pipe indications are not a member of the first list of pipe indications.

The metadata values list display causing and the pipe indications list display causing may be repeated, to thereby accomplish drilling down into the pipes of the first list of pipe indications.

The categories of pipes metadata may include, for example, attributes of the pipe specification itself, attributes by which the pipes have been characterized by users of the pipes, and attributes characterizing execution of the pipes.

### BRIEF DESCRIPTION OF THE DRAWINGS

FIG. 1 is a flowchart illustrating a computer-implemented method to allow users to browse many available pipes.

FIG. 2 illustrates a screen shot in which a list of pipe indications is displayed.

FIG. 3 illustrates a screenshot in which a list of pipe indications is displayed, as a result of activation of a metadata value, relative to the FIG. 2 list of pipe indications.

FIG. 4 graphically illustrates an architecture in which pipe specifications may be executed and metadata may be used to browse the pipes.

FIG. 5 is a simplified diagram of a network environment in which specific embodiments of the present invention may be implemented.

### DETAILED DESCRIPTION

There can be many pipes available for use by a user. The inventors have realized that it would be desirable for the user to be able to select a pipe to use, from the many available pipes, based on metadata characterizing the pipes. The metadata includes metadata that is not discernible from the pipe specification itself including, for example, “tags” provided by a pipe author or other users, running time of the pipe, and many other metadata.

The execution of a pipe may be more generally characterized as a “retrieve and process” operation. That is, the pipe execution processing makes “calls” to other services (e.g., via available API's) to mix and match from multiple data sources (which, in a specific example, are syndication data feeds). More generally, it may be desirable for a user of “retrieve and process” specifications to be able to select a specification for use based on metadata characterizing the specifications, including metadata not discernible from the specifications themselves.

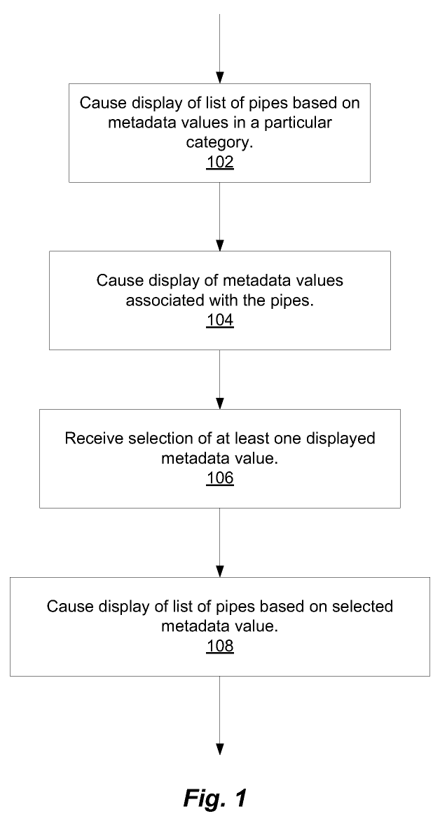

FIG. 1 is a flowchart illustrating an example of a computer-implemented method to allow users to browse available pipes. In describing the FIG. 1 flowchart, we refer to example screenshots to illustrate examples of the FIG. 1 processing. Referring now to FIG. 1, at 102, a display is caused of a list of pipe indications, where the pipes of the list are pipes that are characterized by metadata values that satisfy particular criteria associated with the list.

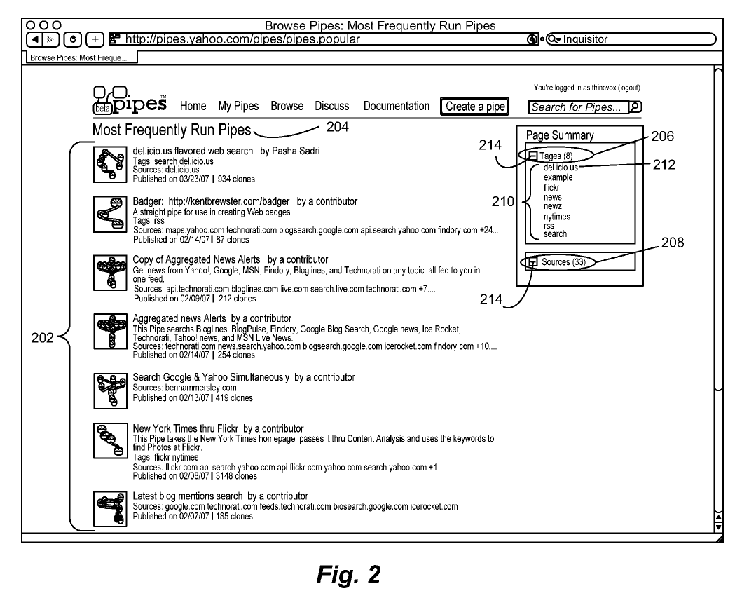

FIG. 2 illustrates a screen shot in which a list 202 of pipe indications is displayed. The pipes of the list 202 have associated metadata in a metadata category 204 entitled “Most Frequently Run Pipes,” which is based on a metadata value corresponding to the number of times each pipe is run exceeding a particular value. The metadata value corresponding to the number of times a pipe is run is not discernible from the pipe itself. Other metadata values, such as syndication data sources accessed from within the pipes may be discernible by inspecting the pipes themselves. For example, metadata values corresponding syndication data sources accessed when a pipe is processed may be discernible from the pipe specification itself.

Returning now to FIG. 1, at 104, display is caused of a list of metadata values associated with the pipes. Referring to FIG. 2, an indication of a metadata category 206—“tags”—is displayed. The display also includes, for the pipes, a list 210 of eight different metadata values for the “tags” metadata category. For example, the “tags” may be tags associated with a pipe by the pipe's author or by another, e.g., via the hosted pipes website. As another example, the “tags” may even be associated with a pipe automatically or semi-automatically. In addition, the display also includes an indication of another metadata category 208—“sources”—with an indication that, for the pipes, there are thirty three different metadata values for the “sources” metadata category. In FIG. 2, the values in each metadata category 206 and 208 can be exposed or hidden using provided user interface elements 214.

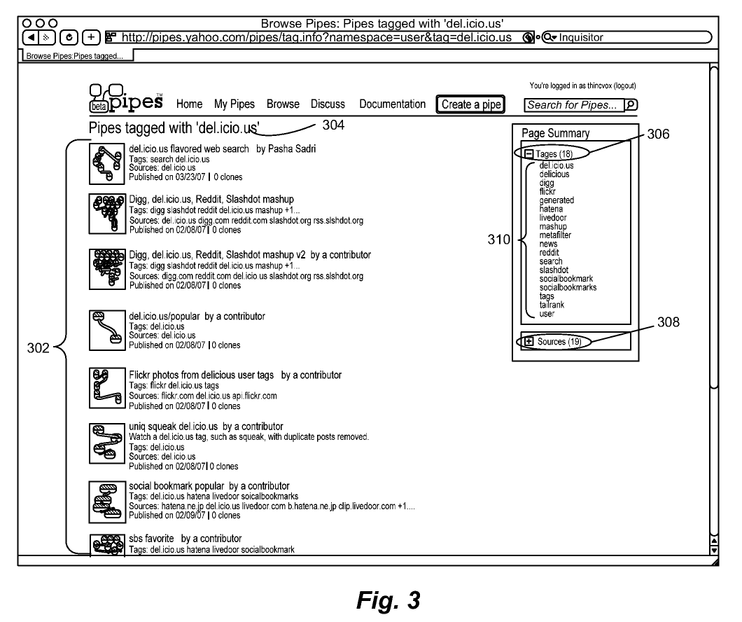

Returning to FIG. 1, at 106, a selection is received of one of the displayed metadata values and, at 108, a list of pipe indications is displayed, for pipes that have the selected metadata value associated with it. For example, FIG. 3 illustrates a screenshot in which a list 302 of pipe indications is displayed. The pipes of the list 302 have associated metadata in a metadata category 304 denoted by “Pipes Tagged with ‘del.icio.us,’” which is based on a metadata value corresponding to tags associated with each pipe. The metadata value corresponding to the “tags” metadata value is not discernible from the pipe itself. As with the FIG. 2 screenshot, the display in the FIG. 3 screenshot includes an indication of two metadata categories 306, 308 and, for the metadata category 306 of “tags,” displays a list 310 of metadata values in the “tags” metadata category.

While the FIG. 2 and FIG. 3 example screenshots illustrate metadata categories of “frequency of running,” “tags” and “sources,” pipe indications and metadata values may be displayed by a number of other metadata categories. Other categories may be selected from the group of, for example, attributes of the pipe specification itself, attributes by which the pipes have been characterized by users of the pipes, and attributes characterizing execution of the pipes. Specific examples of such categories include, for example:

Author
Tag
Sources
Modules
Date
Runs
Copies
Component/Sub-Pipe
Timeout
Average Execution Time
Average Result Items
Languages
Parameters: what are the most common parameters?
Subscribed by User-Agent
Geo-Access
Extensions
Media Types
Favorites
Run diversity
Use Context (Badger, Renderer, etc)

In addition, it should be noted that, when a particular metadata value is selected, the displayed list of pipe indications (such the list 302 of pipe indications) may be limited to be a subset of previous list of pipe indications (such as the list 202 of pipe indications). In this manner, by selecting a particular metadata value, a “drill down” into the pipes may be accomplished. That is, each time a particular metadata value is selected, the resulting list of pipe indications is a subset of the previous list of pipe indications, and only those pipes characterized by the selected metadata value are indicated in the resulting list.

In some examples, the resulting list of pipe indications is independent of the previous list of pipe indications. Thus, in one example, when a particular metadata value is selected, the resulting list indicates all pipes (e.g., from some global set of pipes) characterized by the selected metadata value and is not limited to being a subset of the previous list of pipe indications.

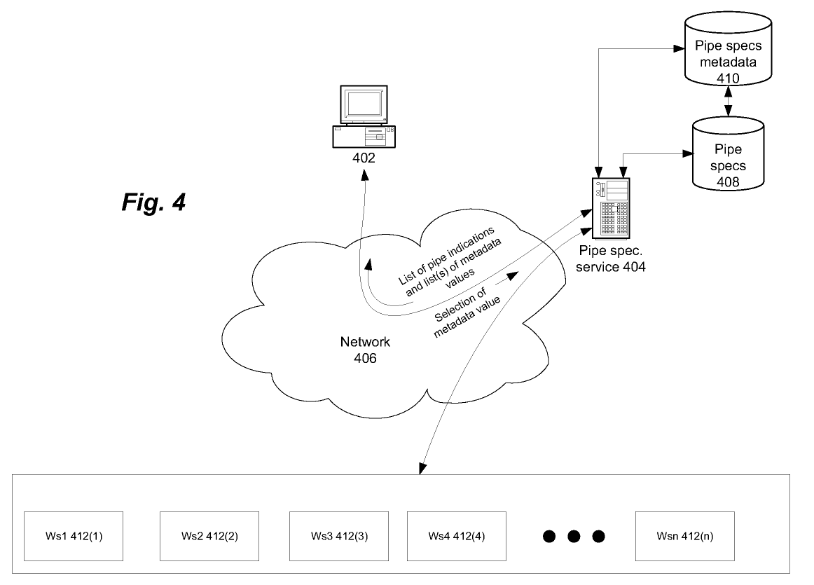

FIG. 4 graphically illustrates an architecture in which pipe specifications may be executed and metadata may be used to browse the pipes. Referring to FIG. 4, a user 402 interoperates with a pipe specification service 404 via a network 406 (such as the internet) to cause the pipe specification service 404 to execute one or more pipe specifications 408. Generically, as disclosed in great detail in the '960 application, executing the one or more pipe specifications includes accessing a plurality of web services 412 (some examples of which are schematically illustrated as web services ws1 412(1), ws2 412(2), ws3 412(3), ws4 412(4), . . . , wsn 412(n)). The web services 412 collectively process syndication data feeds to accomplish execution of a pipe specification 408. A result of processing the pipe specification 408 is provided from the pipe specification service 404 to the user 102.

In browsing the pipe specifications 408, the user 402 is presented a list of pipe indications and one or more lists of corresponding pipe specification metadata values. An indication of user selection of metadata values is provided to the pipe specification service 404 and, based on the pipe specifications 408 and the pipe specification metadata 410, an appropriate list of pipe indications and one or more lists of metadata values are provided to the user 402.

Thus far, we have discussed browsing in the particular context of pipe specifications such as may be created and/or used as disclosed in the '960 application referenced in the Background. A specification of a pipe may be more generally characterized as a specification of a “retrieve and process” operation. That is, the pipe execution processing makes “calls” to other services (e.g., via available API's) to mix and match from multiple data sources (which, in a specific example, may include syndication data feeds). Each specification may have associated metadata values, including metadata values that are not discernible from the specifications themselves.

We thus described a method/system for a user to be able to select a specification to use, from the many available specifications, based on metadata characterizing the specifications. The metadata includes metadata that is not discernible from the specification itself including, for example, “tags” provided by a specification author or other users, running time of the pipe, and many other metadata.

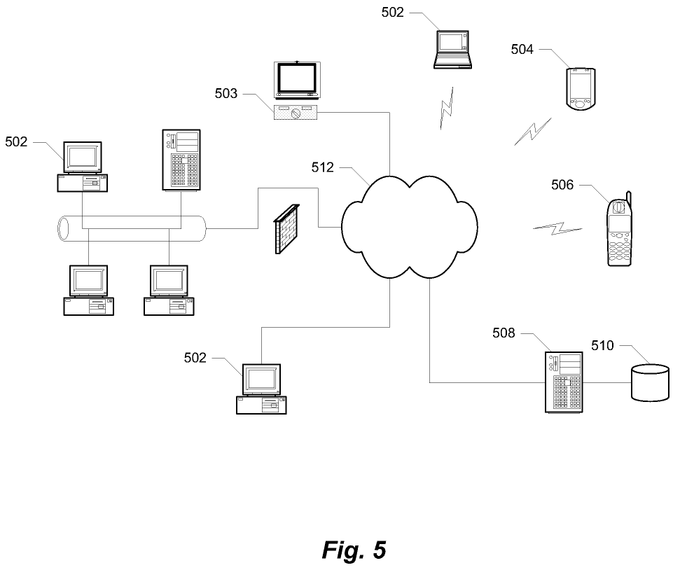

Embodiments of the present invention may be employed in any of a wide variety of computing contexts to provide supplemental material that is appropriate to a nominal expected retrieval and processing time and/or is appropriate to a nominal expected content of the processed specifications for mixing and matching data resulting from various web service calls s. For example, as illustrated in FIG. 5, implementations are contemplated in which users may interact with a diverse network environment via any type of computer (e.g., desktop, laptop, tablet, etc.) 502, media computing platforms 503 (e.g., cable and satellite set top boxes and digital video recorders), handheld computing devices (e.g., PDAs) 504, cell phones 506, or any other type of computing or communication platform.

According to various embodiments, applications may be executed locally, remotely or a combination of both. The remote aspect is illustrated in FIG. 5 by server 508 and data store 510 which, as will be understood, may correspond to multiple distributed devices and data stores.

The various aspects of the invention may also be practiced in a wide variety of network environments (represented by network 512) including, for example, TCP/IP-based networks, telecommunications networks, wireless networks, etc. In addition, the computer program instructions with which embodiments of the invention are implemented may be stored in any type of computer-readable media, and may be executed according to a variety of computing models including, for example, on a stand-alone computing device, or according to a distributed computing model in which various of the functionalities described herein may be effected or employed at different locations.

What is claimed is:

1. A method of operating a user interface configured for browsing pipes, the pipes being characterized by a plurality of metadata values, the plurality of metadata values including metadata values not discernible from the pipes themselves, the method comprising:
causing display of a first list of pipe indications for pipes characterized by metadata values, of at least a first category of metadata, satisfying particular criteria; and
causing display of a first list of metadata values for at least a second category of metadata, other than the first category of metadata, the pipes of the first list of pipe indications being categorized by the metadata values of the first list of metadata values.

2. The method of claim 1, further comprising:
receiving a selection of at least one of the metadata values of the first list of metadata values; and
causing display of a second list of pipe indications characterized by the selected at least one of the metadata values of the received first list of metadata values.

3. The method of claim 2, further comprising:
causing display of a second list of metadata values, the pipes of the second list of pipe indications being categorized by the metadata values of the second list of metadata values.

4. The method of claim 2, wherein:
each pipe of the second list of pipe indications is a member of the first list of pipes indications.

5. The method of claim 2, wherein:
at least some pipes of the second list of pipe indications are not a member of the first list of pipe indications.

6. The method of claim 2, further comprising:
repeating the metadata values list display causing step and the pipe indications list display causing step, to thereby accomplish drilling down into the pipes of the first list of pipe indications.

7. The method of claim 1, wherein:
the second category of metadata include at least one category selected from the group of:
attributes of the pipe specification itself;
attributes by which the pipes have been characterized by users of the pipes; and
attributes characterizing execution of the pipes.

8. A method of operating a user interface configured for browsing retrieve and process specifications, the retrieve and process specifications being characterized by a plurality of metadata values, the plurality of metadata values including metadata values not discernible from the retrieve and process specifications themselves, the method comprising:
causing display of a first list of retrieve and process indications for retrieve and process specifications characterized by metadata values, of at least a first category of metadata, satisfying particular criteria; and
causing display of a first list of metadata values for at least a second category of metadata, other than the first category of metadata, the pipes of the first list of retrieve and process specification indications being categorized by the metadata values of the first list of metadata values.

9. A system including at least one computing device and configured to operate a user interface to browse pipes, the pipes being characterized by a plurality of metadata values, the plurality of metadata values including metadata values not discernible from the pipes themselves, the at least one computing device configured to:
cause display of a first list of pipe indications for pipes characterized by metadata values, of at least a first category of metadata, satisfying particular criteria; and
cause display of a first list of metadata values for at least a second category of metadata, other than the first category of metadata, the pipes of the first list of pipe indications being categorized by the metadata values of the first list of metadata values.

10. The system of claim 9, the at least comprising device further configured to:
receive a selection of at least one of the metadata values of the first list of metadata values; and
cause display of a second list of pipe indications characterized by the selected at least one of the metadata values of the received first list of metadata values.

11. The system method of claim 10, the at least one computing device further configured to:
cause display of a second list of metadata values, the pipes of the second list of pipe indications being categorized by the metadata values of the second list of metadata values.

12. The system of claim 10, wherein:
each pipe of the second list of pipe indications is a member of the first list of pipes indications.

13. The system of claim 10, wherein:
at least some pipes of the second list of pipe indications are not a member of the first list of pipe indications.

14. The system of claim 10, the at least one computing device further configured to:
repeat the metadata values list display causing and the pipe indications list display causing, to thereby accomplish drilling down into the pipes of the first list of pipe indications.

15. The system of claim 9, wherein:
the second category of metadata include at least one category selected from the group of:
attributes of the pipe specification itself;
attributes by which the pipes have been characterized by users of the pipes; and
attributes characterizing execution of the pipes.

16. A system including at least one computing device and configured to operate a user interface configured for browsing retrieve and process specifications, the retrieve and process specifications being characterized by a plurality of metadata values, the plurality of metadata values including metadata values not discernible from the retrieve and process specifications themselves, the at least one computing device configured to:
cause display of a first list of retrieve and process indications for retrieve and process specifications characterized by metadata values, of at least a first category of metadata, satisfying particular criteria; and
cause display of a first list of metadata values for at least a second category of metadata, other than the first category of metadata, the pipes of the first list of retrieve and process specification indications being categorized by the metadata values of the first list of metadata values.
